(19) United States
(12) Patent Application Publication
(10) Pub. No.: US 2017/0330236 A1
(43) Pub. Date: Nov. 16, 2017

(54) ENHANCING CONTACT CARD BASED ON KNOWLEDGE GRAPH

(71) Applicant: MICROSOFT TECHNOLOGY LICENSING, LLC, Redmond, WA (US)

(72) Inventor: Megan Quintero, Seattle, WA (US)

(73) Assignee: MICROSOFT TECHNOLOGY LICENSING, LLC, Redmond, WA (US)

(21) Appl. No.: 15/150,446

(22) Filed: May 10, 2016

(51) Int. Cl. G06Q 30/02; G06Q 20/34; G06F 17/30; G06Q 30/06; G06K 19/067

(52) U.S. Cl. CPC G06Q 30/0256; G06Q 30/0625; G06Q 20/346; G06K 19/067; G06F 17/30554; G06F 17/3087; G06F 17/30867; G06F 17/30958

(57) ABSTRACT

A contact card is enhanced based on a knowledge graph. A communication application initiates operations to enhance a smart contact card upon receiving a communication from an organization or brand. A knowledge graph is queried to retrieve an association information between a recipient of the communication and the organization or brand. The association information is matched to an interest of the recipient. The association information is also inserted into a smart contact card of the organization or brand. A control element to interact with the association information is inserted into the smart contact card as well. Furthermore, the smart contact card is presented to the recipient.

### BACKGROUND

Information collection, management, and analysis have changed work processes associated communication management and product purchase. Automation and improvements in work processes have expanded scope of capabilities offered by businesses. With the development of faster and smaller electronics execution of mass processes at purchase analysis systems have become feasible. Indeed, analysis work at data centers, data warehouses, data workstations have become common business features in modern work environments. Such systems execute a wide variety of applications ranging from enterprise resource management applications to communication solutions to manage procurement of products. Many such applications process purchase data to attempt to improve communications associated with purchase of products and interactions with vendors.

Vast number of provider sources and product types complicate purchase management. Indeed, fast changing dynamics of product market may cause difficulties in making the correct choices in timely product purchase at market values. Complications with multiple provider sources, product types, and complexity of the product offers may lead to mismanagement of product related communication and underutilization of offers to procure products by interested parties.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enhancing a contact card based on a knowledge graph without explicit action and/or input by an entity associated with the contact card. A communication application, according to embodiments, may initiate operations to enhance the contact card upon receiving a communication from an organization or a brand. Next, a knowledge graph may be queried to retrieve an association information between a recipient of the communication and the organization or brand. The association information may match an interest of the recipient. The association information may be inserted into a smart contact card of the organization or brand. A control element to interact with the association information may also be inserted into the smart contact card. Furthermore, the smart contact card may be presented to the recipient.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1A through 1B are conceptual diagrams illustrating examples of enhancing a contact card based on a knowledge graph, according to embodiments;

FIG. 2 is a display diagram illustrating example components of a communication application that enhances a contact card based on a knowledge graph, according to embodiments;

FIG. 3 is a display diagram illustrating an example interface that enhances a smart contact card based on a knowledge graph, according to embodiments;

FIG. 4 is a display diagram illustrating an example of a smart contact card that is enhanced based on a knowledge graph, according to embodiments;

FIG. 5 is a simplified networked environment, where a system according to embodiments may be implemented;

FIG. 6 is a block diagram of an example computing device, which may be used to enhance a smart contact card based on a knowledge graph, according to embodiments; and

FIG. 7 is a logic flow diagram illustrating a process for enhancing a smart contact card based on a knowledge graph, according to embodiments.

### DETAILED DESCRIPTION

As briefly described above, a smart contact card may be enhanced based on a knowledge graph by a communication application. In an example scenario, the communication application may receive a communication from an organization or brand. The communication may include a message, an email, a conference call, and/or a call, among others. The organization may include a vendor. The brand may include a type of an item sold by the vendor.

The communication application may query a knowledge graph to retrieve an association information between a recipient of the communication and the organization. The knowledge graph may include a data structure (maintained by the communication application or another entity) that hosts contact information and information of interest about the organization or brand to the recipient. The association information may include a contact number of interest to the recipient, and/or a location of a nearest store of the organization/brand, among others. The association information may match the interest of the recipient. The interest may be determined based on past interactions between the recipient, the organization or brand, and/or an item provided by the organization or brand, among others.

Next, the communication application may insert the association information into a smart contact card of the organization or brand. A control element with operations to interact with the association information may be inserted into the smart contact card as well. Furthermore, the smart contact card may be presented to the recipient.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to enhance a contact card based on a knowledge graph. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

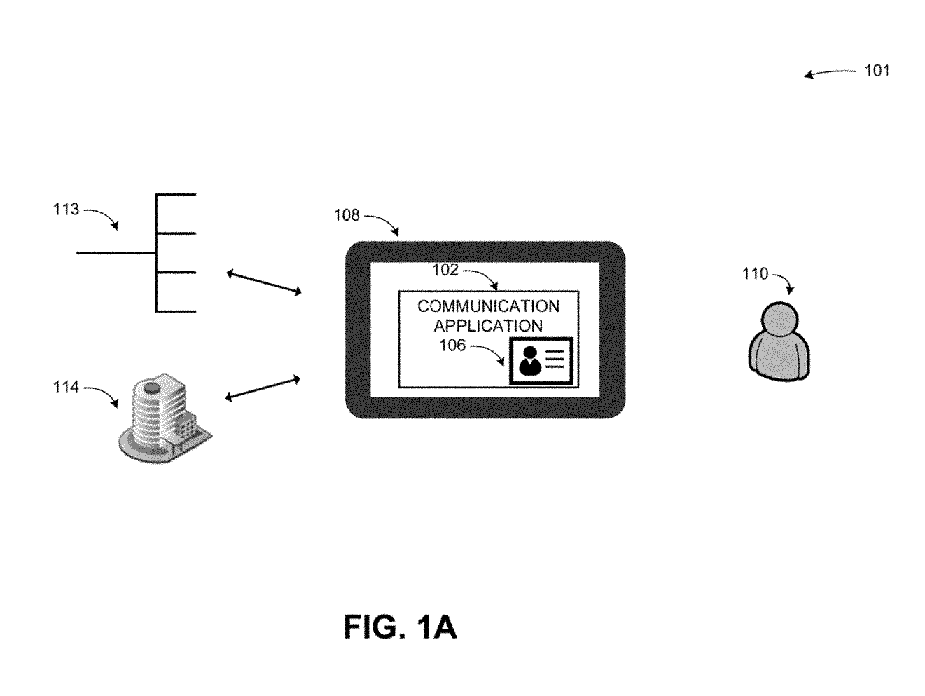

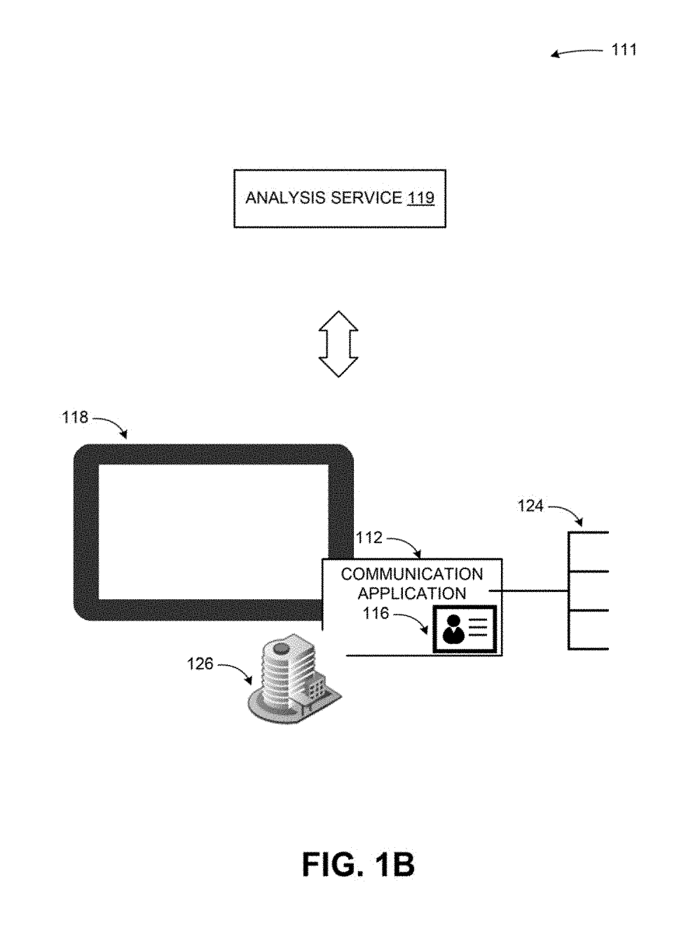

FIG. 1A through 1B are conceptual diagrams illustrating examples of enhancing a contact card based on a knowledge graph, according to embodiments.

In a diagram 101, a computing device 108 may execute a communication application 102. The computing device 108 may include a desktop computer, a mobile computer, and/or a physical server that provide service(s) and/or application(s). A service may include an application performing operations in relation to a client application and/or a subscriber, among others.

The computing device 108 may execute the communication application 102. The communication application 102 may initiate operations to enhance a smart contact card 106 based on a knowledge graph 113 upon receiving a communication from an organization or brand 114. In the example configuration of FIG. 1A, the organization may include a vendor. The brand may include a type of item that the recipient 110 may have an interest. Next, the knowledge graph 113 may be queried to retrieve an association information between the recipient 110 and the organization or brand 114. The knowledge graph may include a structured (or unstructured) data store that may host contact and interest information associated with the organization or brand 114. The association information may be matched to an interest of the recipient that may be identified based on past interactions of the recipient 110 and the organization or brand 114 (such as past purchases).

The association information may be inserted into the smart contact card 106 of the organization or brand 114. A control element to interact with the association information may also be inserted into the smart contact card to allow the recipient 110 to interact with the association information (for example, activating a link to a map with directions to a nearest store of the organization or brand 114). The communication application 102 may also present the smart contact card to the recipient.

The computing device 108 may communicate with other device (for example a server) through a network. The network may provide wired or wireless communications between nodes such as the other device, or the computing device 108, among others. Previous example(s) to enhance a smart contact card 106 based on a knowledge graph 113 are not provided in a limiting sense. Alternatively, the communication application 102 may manage the smart contact card 106 at a desktop application, a workstation application, and/or a server application, among others. The communication application 102 may also render a client interface of a service.

The recipient 110 may interact with the communication application 102 with a keyboard based input, a mouse based input, a voice based input, a pen based input, and a gesture based input, among others. The gesture based input may include one or more touch based actions such as a touch action, a swipe action, and a combination of each, among others.

In a diagram 111 of FIG. 18, the communication application 112 (executing in a computing device 118) may interact with an analysis service 119 to process a communication to identify an association information between a recipient and an organization or brand 126. The analysis service may add the association information into a knowledge graph 124. The association information may also be retrieved from the knowledge graph 124 and matched to an interest of the recipient. Upon matching, the association information may be inserted into a smart contact card 116 of the organization or brand 126. The analysis service 119 may include a third party service provider. The communication application 112 may remove private information from any interaction with the analysis service 119 to anonymize data transmitted to the analysis service 119.

While the example systems in FIG. 1A through 18 have been described with specific components including the computing device 108, the communication application 102, embodiments are not limited to these components or system configurations and can be implemented with other system configuration employing fewer or additional components.

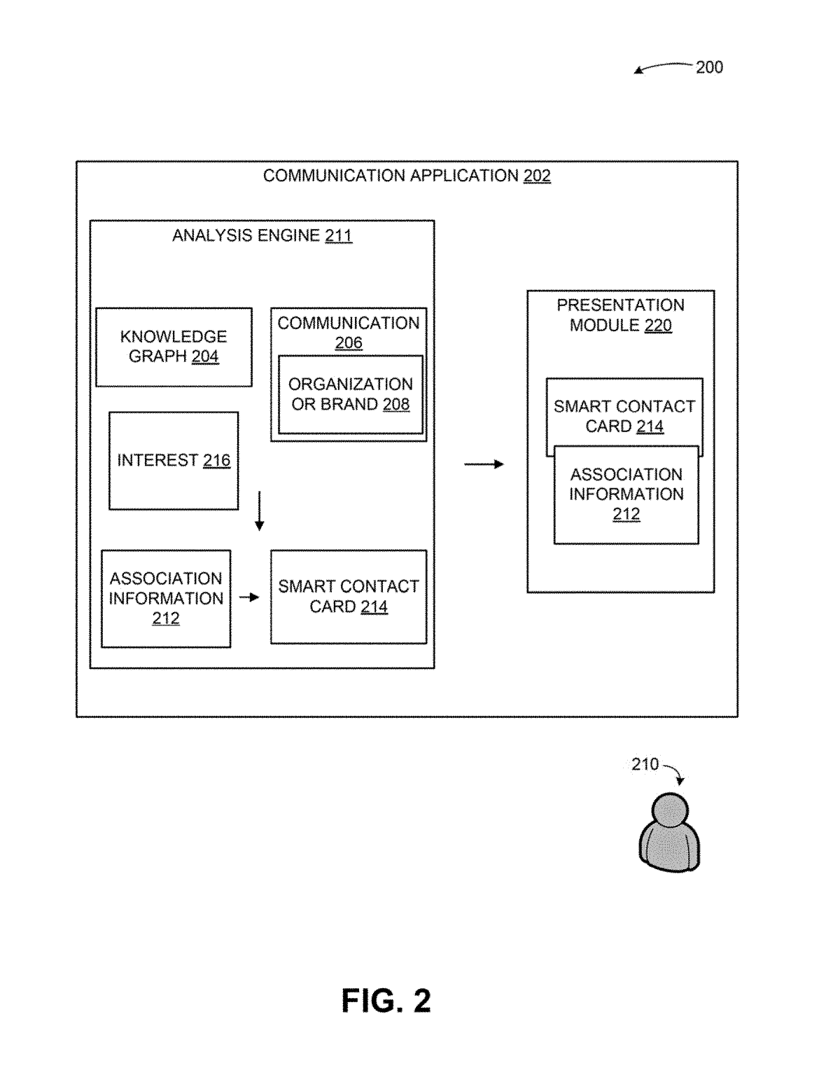

FIG. 2 is a display diagram illustrating example components of a communication application that enhances a contact card based on a knowledge graph, according to embodiments.

In a diagram 200, a communication application 202 may receive a communication 206 from an organization or brand 208. The communication 206 may include a promotion associated with an item provided by the organization or brand 208. The organization or brand 208 may be identified in a metadata of the communication 206 as the sender of the communication 206. As such, the organization or brand 208 may be personified as a contact for a recipient 210 of the communication 206 allowing the recipient 210 to interact with the organization or brand 208 in a personal representation.

An analysis engine 211 of the communication application 202 may query a knowledge graph 204 to retrieve an association information 212 between a recipient 210 of the communication 206 and the organization or brand 208. The knowledge graph 204 may include a data store of contact and/or interest information associated with the organization or brand 208 that may be maintained by the communication application 202 or other entity. The association information may include a contact number for a department of the organization or brand 208, a description of the organization or brand 208, a promotion associated with an item provided by the organization or brand 208, a review of the organization or brand 208, a location of a store of the organization or brand 208, and/or a link to a third party informational source that describes the organization or brand, among others.

The association information may also be detected to match an interest 216 of the recipient 210. The interest 216 may be identified from a past interaction analysis between the recipient 210 and the organization or brand 208 such as a past purchase frequency of item(s) from the organization or brand 208. Next, the association information 212 may be inserted into a smart contact card 214 of the organization or brand 208. A control element may also be inserted into the smart contact card to allow an Interaction with the association information 212 (for example, a link to access the association information such as documents associated with the organization or brand 208).

The analysis engine 211 may transmit the smart contact card 214 that includes the association information 212 to a presentation module 220 of the communication application 202 for a presentation to the recipient 210. The presentation module 220 may present the smart contact card 214 to the recipient to inform the recipient of the association information 212 that is of an interest 216 to the recipient 210.

In an example scenario, the analysis engine 211 may process the communication 206 to identify the association information 212. Upon identification, the association information 212 may be added to the knowledge graph 204.

The interest 216 of the recipient 210 in the association information 212 may be identified based on a past interaction history (such as a purchase from the organization or brand 208) with the association information 212. For example, interaction(s) between contact number of the organization or brand 208 and the recipient 210 may be analyzed to identify a frequency and a recentness of the interactions. Next, a number of recipient interaction(s) in relation to the association information 212 may be correlated with the interest 216 of the recipient 210. For example, a high number of the interactions may correlate to a high interest. A low number of interactions may correlate to a low interest. Similarly, a recent interaction may correlate to a high interest. A distant interaction may correlate to a low interest. Association information 212 correlated to a high interest (or a medium level interest) may be processed for insertion into the smart contact card 214. While, the association information 212 correlated to a low interest may not be processed.

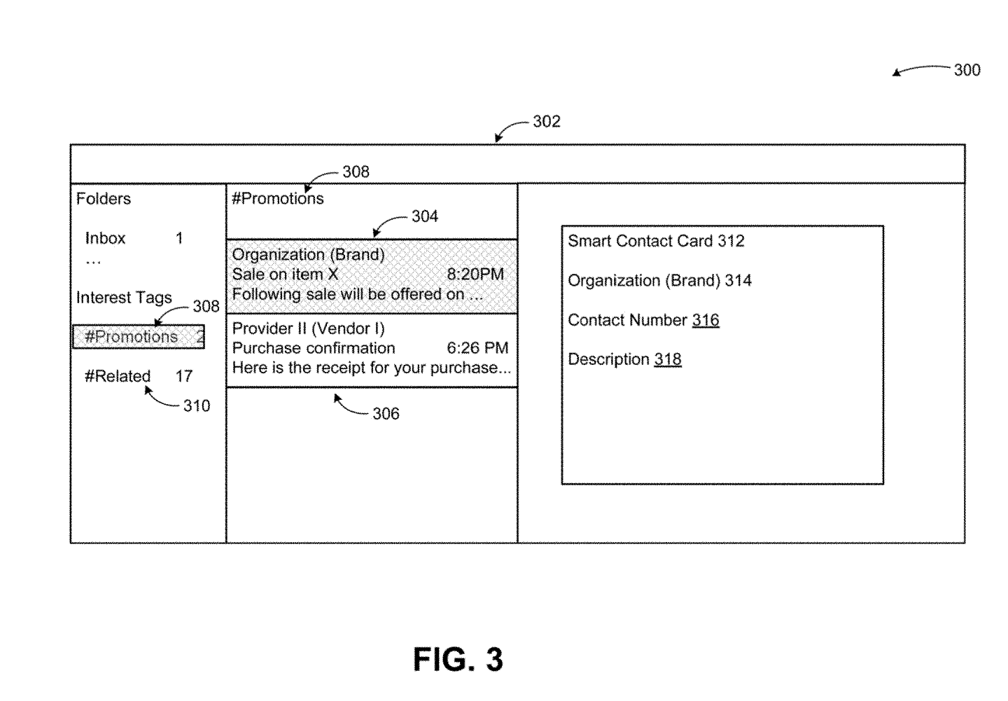

FIG. 3 is a display diagram illustrating an example interface that enhances a contact card based on a knowledge graph, according to embodiments.

In a diagram 300, a communication application 302 may provide a communication 304 to a recipient. The communication 304 and the communication 306 may be classified with a tag category 308 based on attributes that match the tag category 308. Other tag category 310 may also host the communication 304 or the communication 306 or other communication that match the tag category 310. The tag category 308 may inform the recipient that the communications (304 and 306) include an attribute, a content, and/or a component, among others that match a tag used to label the communications (304 and 306). For example, the communication 304 may be from an organization or brand that is an interest to the recipient of the communication 304. The communication 304 may include a promotion associated with an item provided by the organization or brand.

In response to an action by the recipient on the communication 304, the communication application may present a smart contact card 312 of the organization or brand 314 that is enhanced based on a knowledge graph. Association information (such as a contact number 316 of a department of the organization or brand 314 and/or a description 318 of the organization or brand 314) may be inserted into the smart contact card and presented to the recipient of the communication 304. The recipient may be provided with a control element for all or some of the association information (such as the contact number 316 or the description 318) to interact with the association information. For example, the contact number 316 may be provided with a control element with operations to initiate a communication session with a corresponding department of interest at the organization or brand 314 and the recipient. The description 318 may be provided with a control element with operations to display a reading interface to provide the description 318. The association information may be highlighted with a scheme to inform the recipient of an availability of control elements to interact with the association information.

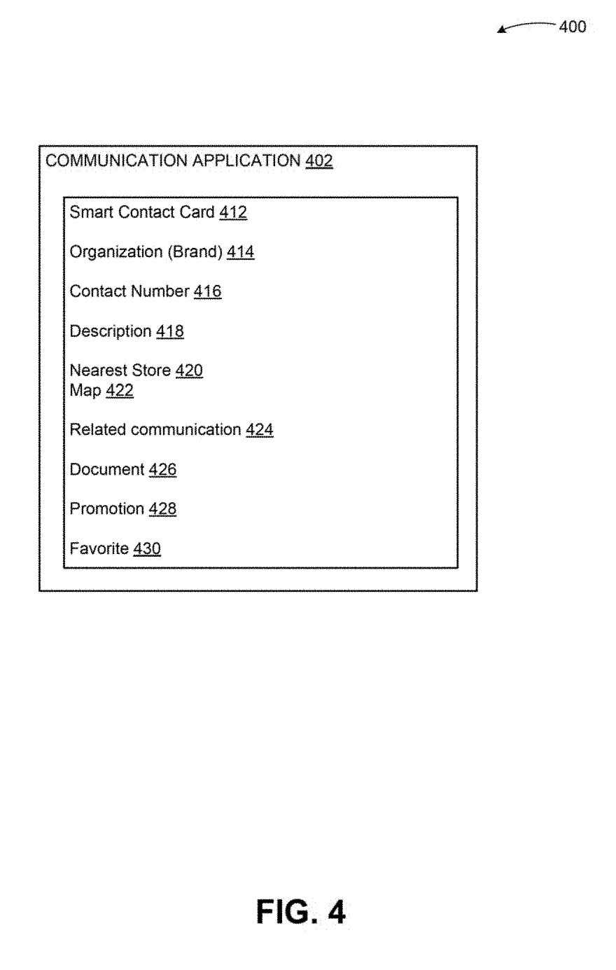

FIG. 4 is a display diagram illustrating an example of a smart contact card that is enhanced based on a knowledge graph, according to embodiments.

In a diagram 400, a communication application 402 may enhance a smart contact card 412 with association information between an organization or brand 414 and a recipient of communication from the organization or brand 414. In an example scenario, the communication application 402 may identify a location of the recipient (by accessing a presence information of the recipient). A knowledge graph of association information may be queried to detect a nearest location of a store 420 of the organization or brand 414 in relation to the location of the recipient. Next, the nearest location of the store 420 of the organization or brand 414 may be inserted into the smart contact card 412 for a presentation to the recipient. The nearest location of the store 420 may be provided with a control element with operations to interact with the association information such as provide an address, and/or copy and paste, among others.

Furthermore, the communication application 402 may provide the association information with a link to a map 422 with directions from the location of the recipient to the nearest location of the store 420 of the organization or brand 414. A graphical representation of the map 422 may also be provided with the association information within the smart contact card. The graphical representation may include a scaled image or graphic or the map 422 with directions.

In another example scenario, the communication application 402 may detect a change to the location of the recipient (through the presence information of the recipient). The knowledge graph may be re-queried to detect the nearest location of other store of the organization or brand in relation to the changed location of the recipient. The association information (the nearest location of the store 420) displayed in the smart contact card may be updated with the nearest location of the other store of the organization or brand 414. Furthermore, the association information in the smart contact card 412 may be changed based on a context associated with the recipient and the organization or brand 414. For example, the nearest location of the store 420 may be changed for other recipient who accesses the smart contact card 412 based on a location of the other recipient in relation to the nearest location of the store 420. Other store of the organization or brand 414 may be determined to be closer to the other recipient.

The knowledge graph may also be queried for a contact number 416 for the organization or brand 414. A number of interactions of the recipient with the contact number 416 may be identified as the interest of the recipient in the contact number 416. The number of interactions are detected to exceed a threshold number that validates the interest (the threshold number may be configurable). Next, the contact number 416 may be inserted as the association information into the smart contact card. The communication application 402 may also display a control element with operations to initiate a communication session with the contact number 416.

The knowledge graph may also be queried for a promotion offered by the organization or brand 414. The interest of the recipient in an item of the organization or brand 414 may be verified by confirming a past purchase of the item by the recipient. Next, the promotion may be inserted as the association information into the smart contact card 412.

The knowledge graph may also be queried for other promotions offered by the organization or brand 414. The interest of the recipient may be detected in a subset of the other promotions based on a past purchase history of the recipient for the other items in the subset of the other promotions. Next, the subset of the other promotions may be inserted as the association information into the smart contact card.

Similarly, a description 418 of the organization or brand 414 may be searched in the knowledge graph. Upon locating the description 418 in the knowledge graph, the description 418 may be inserted as the association information into the smart contact card 412.

In an example scenario, the communication application 402 may detect the interest of the recipient to search a related communication 424 (sent to the recipient) by the organization or brand 414. The knowledge graph may be searched for the related communication 424. Upon locating the related communication 424, a link to the related communication 424 may be inserted into the smart contact card 412 as the association information.

In another example scenario, the communication application 402 may detect the interest of the recipient to search for a document 426 related to the organization or brand 414. The knowledge graph may be searched for the document 426. In response to locating the document 426, a link to the document 426 may be inserted into the smart contact card 412 as the association information.

Similarly, the communication application 402 may detect an interest of the recipient to read a review (or view a third party information source) in relation to the organization or brand 414. The knowledge graph may be searched for the review (or for the third party information source with an article on the organization or brand 414). The review (or a link to third party information source with the article on the organization or brand 414) may be inserted into the smart contact card 412 as the association information.

Furthermore, the communication application 402 may identify the interest of the recipient to classify the organization or brand 414 as a favorite 430. The organization or brand may be stored as the favorite 430 in the knowledge graph. An indicator may be inserted into the smart contact card to label the organization or brand 414 as the favorite 430.

As discussed above, the communication application may be employed to perform operations to automate enhancement of a contact card based on a knowledge graph. An increased user efficiency with the communication application 102 may occur as a result of searching a knowledge graph for an association information and inserting the association information into a smart contact card. Additionally, analyzing the communication, and the association information, and the organization or brand, by the communication application 102, may reduce processor load, increase processing speed, conserve memory, and reduce network bandwidth usage.

Embodiments, as described herein, address a need that arises from a lack of efficiency to enhance a contact card based on a knowledge graph. The actions/operations described herein are not a mere use of a computer, but address results that are a direct consequence of software used as a service offered to large numbers of users and applications.

The example scenarios and schemas in FIG. 1A through 4 are shown with specific components, data types, and configurations. Embodiments are not limited to systems according to these example configurations. Enhancing a contact card based on a knowledge graph may be implemented in configurations employing fewer or additional components in applications and user interfaces. Furthermore, the example schema and components shown in FIG. 1A through 4 and their subcomponents may be implemented in a similar manner with other values using the principles described herein.

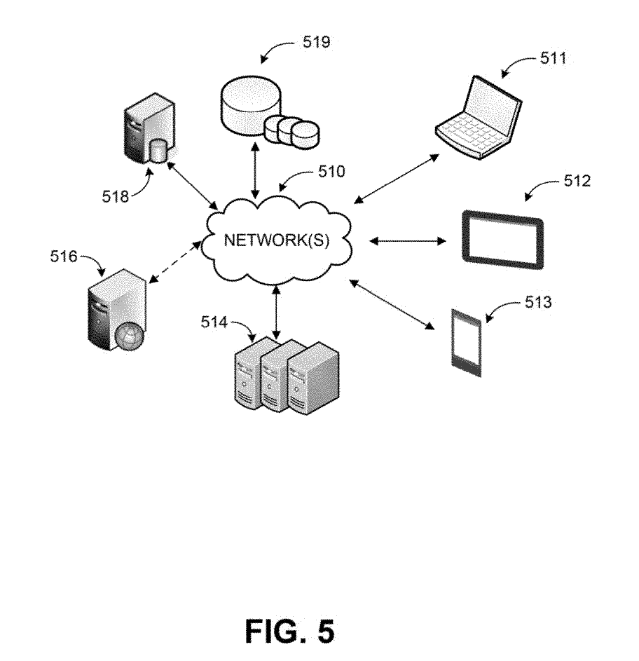

FIG. 5 is an example networked environment, where embodiments may be implemented. A communication application configured to enhance a contact card based on a knowledge graph may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A communication application may query a knowledge graph to retrieve an association information between a recipient of a communication and the organization or brand (upon receiving the communication). The association information may match an interest of the recipient. The association information may be inserted into a smart contact card of the organization or brand. A control element to interact with the association information may also be inserted into the smart contact card. Furthermore, the smart contact card may be presented to the recipient. The communication application may store data associated with the organization or brand in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to enhance a contact card based on a knowledge graph. Furthermore, the networked environments discussed in FIG. 5 are for illustration purposes only. Embodiments are not limited to the example applications, modules, or processes.

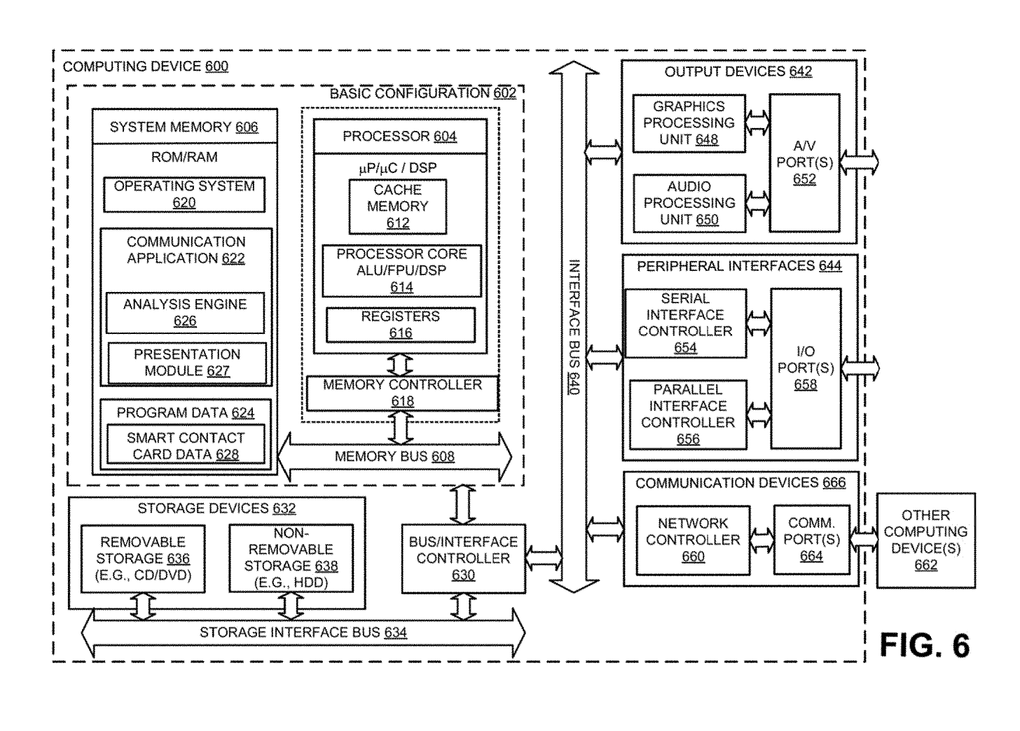

FIG. 6 is a block diagram of an example computing device, which may be used to enhance a contact card based on a knowledge graph, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (lP), a microcontroller (gIC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication application 622, and a program data 624. The communication application 622 may include components such as an analysis engine 626 and a presentation module 627. The analysis engine 626 and the presentation module 627 may execute the processes associated with the communication application 622. The analysis engine 626 may query a knowledge graph to retrieve an association information between a recipient of a communication and the organization or brand (upon receiving the communication). The association information may match an interest of the recipient. The association information may be inserted into a smart contact card of the organization or brand. A control element to interact with the association information may also be inserted into the smart contact card. The presentation module 627 may present the smart contact card to the recipient.

Components of the communication application 622 (such as a user interface) may also be displayed on a display device associated with the computing device 600. An example of the display device may include a hardware screen that may be communicatively coupled to the computing device 600. The display device may include a touch based device that detects gestures such as a touch action. The display device may also provide feedback in response to detected gestures (or any other form of input) by transforming a user interface of the communication application 622, displayed by the touch based device. The program data 624 may also include, among other data, smart contact card data 628, or the like, as described herein. The smart contact card data 628 may include an association information, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to enhance a contact card based on a knowledge graph. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

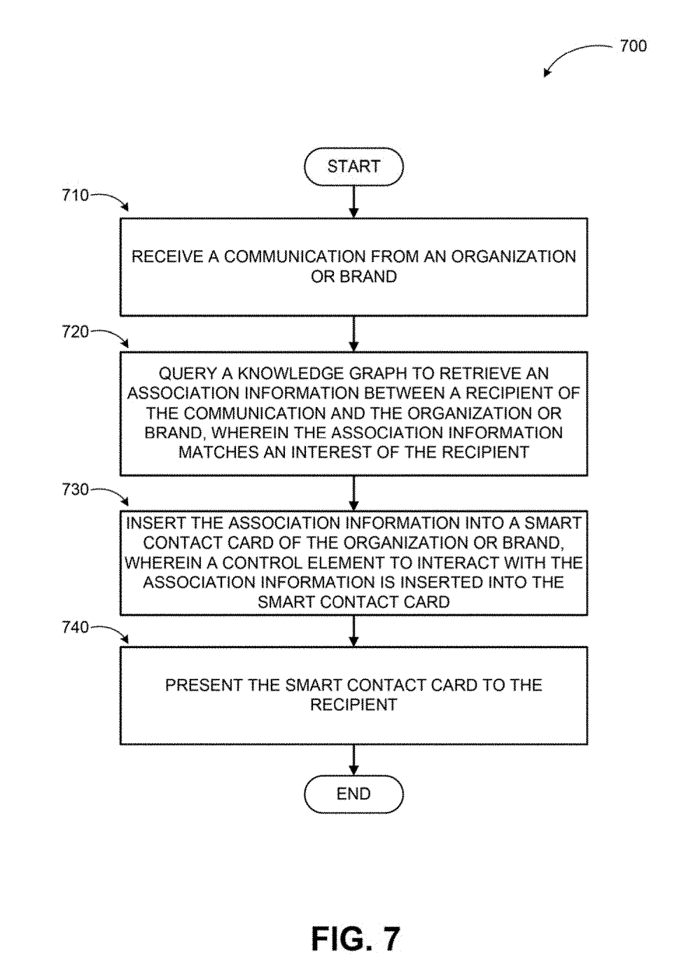

FIG. 7 is a logic flow diagram illustrating a process for enhancing a contact card based on a knowledge graph, according to embodiments. Process 700 may be implemented on a computing device, such as the computing device 600 or another system.

Process 700 begins with operation 710, where the communication application receives a communication from an organization or brand. Next, at operation 720, a knowledge graph may be queried to retrieve an association information between a recipient of the communication and the organization or brand. The association information may be matched to an interest of the recipient.

At operation 730, the association information may be inserted into a smart contact card of the organization or brand. A control element to interact with the association information may be inserted into the smart contact card. Next, at operation 740, the smart contact card may be presented to a recipient.

The operations included in process 700 are for illustration purposes. Enhancing a contact card based on a knowledge graph may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device to enhance a contact card based on a knowledge graph is described. The computing device includes a display device, a memory configured to store instructions associated with a communication application, processor(s) coupled to the memory and the communication device. The processor(s) execute the communication application in conjunction with the instructions stored in the memory. The communication application includes an analysis engine and a presentation module. The analysis engine is configured to receive a communication from an organization or a brand, query a knowledge graph to retrieve an association information between a recipient of the communication and the organization or the brand, where the association information matches an interest of the recipient, and insert the association information into a smart contact card of the organization or brand, where a control element to interact with the association information is inserted into the smart contact card. The presentation module is configured to present, through the display device, the smart contact card to be displayed to the recipient.

In other examples, the analysis engine is further configured to process the communication to identify the association information and add the association information into the knowledge graph. The association information includes one or more of a contact number for a department of the organization or the brand, a description of the organization or the brand, a promotion associated with an item provided by the organization or the brand, a review of the organization or the brand, a location of a store of the organization or the brand, and a link to a third party informational source that describes the organization or the brand.

In further examples, the analysis engine is further configured to identify an interest of the recipient in the association information based on a past interaction history with the association information and correlate a number of recipient interactions in relation to the association information with the interest of the recipient, where a high number of the interactions correlates to a high interest and a low number of the interactions correlates to a low interest. The analysis engine is further configured to identify a location of the recipient, query the knowledge graph to detect a nearest location of a store of the organization or the brand in relation to the location of the recipient, and insert the nearest location of the store of the organization or the brand as the association information into the smart contact card. The analysis engine is further configured to provide the association information with a link to a map with directions from the location of the recipient to the nearest location of the store of the organization or the brand and include a graphical representation of the map in the association information. The analysis engine is further configured to detect a change to the location of the recipient, query the knowledge graph to detect the nearest location of other store of the organization or the brand in relation to the changed location of the recipient, and update the association information in the smart contact card with the nearest location of the other store of the organization or brand.

In other examples, the analysis engine is further configured to query the knowledge graph for a contact number for the organization or brand, identify a number of interactions of the recipient with the contact number as the interest of the recipient in the contact number, where the number interactions exceed a threshold number, and insert the contact number as the association information into the smart contact card, where the control element is configured to initiate a communication session with the contact number. The analysis engine is further configured to query the knowledge graph for a promotion offered by the organization or the brand, verify the interest of the recipient in an item described by the promotion by confirming a past purchase of the item by the recipient, and insert the promotion as the association information into the smart contact card. The analysis engine is further configured to query the knowledge graph for other promotions offered by the organization or the brand, detect the interest of the recipient in a subset of the other promotions based on a past purchase history of the recipient for other items in the subset of the other promotions, and insert the subset of the other promotions as the association information into the smart contact card. The analysis engine is further configured to query the knowledge graph for a description of the organization or the brand and insert the description as the association information into the smart contact card.

In some examples, a method executed on a computing device to enhance a contact card based on a knowledge graph is described. The method includes receiving a communication from an organization, processing the communication to identify an association information between a recipient of the communication and the organization, adding the association information into a knowledge graph, querying the knowledge graph to retrieve the association information, where the association information matches an interest of the recipient, inserting the association information to a smart contact card of the organization, where a control element to interact with the association information is inserted into the smart contact card, and presenting the smart contact card to the recipient.

In other examples, the method further includes searching the knowledge graph for a related communication sent by the organization and inserting a link to the related communication into the smart contact card as the association information. The method further includes searching the knowledge graph for a document related to the organization; and inserting a link to the document into the smart contact card as the association information. The method further includes searching the knowledge graph for a review associated with the organization and inserting the review into the smart contact card as the association information. The method further includes searching the knowledge graph for a third party information source with an article on the organization and inserting a link to the third party information source with the article on the organization as the association information into the smart contact card. The method further includes detecting a classification of the organization as a favorite by the recipient, storing the organization as the favorite in the knowledge graph, and inserting an indicator into the smart contact card to label the organization as the favorite.

In some examples a computer-readable memory device with instructions stored thereon to enhance a contact card based on a knowledge graph is described. The instructions include actions similar to the actions of the method.

In some example a means for enhancing a contact card based on a knowledge graph is described. The means for enhancing a contact card based on a knowledge graph includes a means for receiving a communication from an organization or a brand, a means for querying a knowledge graph to retrieve an association information between a recipient of the communication and the organization or the brand, where the association information matches an interest of the recipient, a means for inserting the association information into a smart contact card of the organization or brand, where a control element to interact with the association information is inserted into the smart contact card, and a means for presenting the smart contact card to be displayed to the recipient.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to enhance a contact card based on a knowledge graph, the computing device comprising:
a display device;
a memory configured to store instructions associated with a communication application;
one or more processors coupled to the memory and the communication device, the one or more processors executing the communication application in conjunction with the instructions stored in the memory, wherein the communication application includes:
an analysis engine configured to:
receive a communication from an organization or a brand;
query a knowledge graph to retrieve an association information between a recipient of the communication and the organization or the brand, wherein the association information matches an interest of the recipient;
insert the association information into a smart contact card of the organization or brand, wherein a control element to interact with the association information is inserted into the smart contact card;
a presentation module configured to:
present, through the display device, the smart contact card to be displayed to the recipient.

2. The computing device of claim 1, wherein the analysis engine is further configured to:
process the communication to identify the association information; and
add the association information into the knowledge graph.

3. The computing device of claim 1, wherein the association information includes one or more of:
a contact number for a department of the organization or the brand,
a description of the organization or the brand,
a promotion associated with an item provided by the organization or the brand,
a review of the organization or the brand,
a location of a store of the organization or the brand, and
a link to a third party informational source that describes the organization or the brand.

4. The computing device of claim 1, wherein the analysis engine is further configured to:
identify an interest of the recipient in the association information based on a past interaction history with the association information; and
correlate a number of recipient interactions in relation to the association information with the interest of the recipient, wherein a high number of the interactions correlates to a high interest and a low number of the interactions correlates to a low interest.

5. The computing device of claim 1, wherein the analysis engine is further configured to:
identify a location of the recipient;
query the knowledge graph to detect a nearest location of a store of the organization or the brand in relation to the location of the recipient; and
insert the nearest location of the store of the organization or the brand as the association information into the smart contact card.

6. The computing device of claim 5, wherein the analysis engine is further configured to:
provide the association information with a link to a map with directions from the location of the recipient to the nearest location of the store of the organization or the brand; and
include a graphical representation of the map in the association information.

7. The computing device of claim 5, wherein the analysis engine is further configured to:
detect a change to the location of the recipient;
query the knowledge graph to detect the nearest location of other store of the organization or the brand in relation to the changed location of the recipient; and
update the association information in the smart contact card with the nearest location of the other store of the organization or brand.

8. The computing device of claim 1, wherein the analysis engine is further configured to:
query the knowledge graph for a contact number for the organization or brand;
identify a number of interactions of the recipient with the contact number as the interest of the recipient in the contact number, wherein the number interactions exceed a threshold number; and
insert the contact number as the association information into the smart contact card, wherein the control element is configured to initiate a communication session with the contact number.

9. The computing device of claim 1, wherein the analysis engine is further configured to:
query the knowledge graph for a promotion offered by the organization or the brand;
verify the interest of the recipient in an item described by the promotion by confirming a past purchase of the item by the recipient; and
insert the promotion as the association information into the smart contact card.

10. The computing device of claim 9, wherein the analysis engine is further configured to:
query the knowledge graph for other promotions offered by the organization or the brand;
detect the interest of the recipient in a subset of the other promotions based on a past purchase history of the recipient for other items in the subset of the other promotions; and
insert the subset of the other promotions as the association information into the smart contact card.

11. The computing device of claim 1, wherein the analysis engine is further configured to:
query the knowledge graph for a description of the organization or the brand; and
insert the description as the association information into the smart contact card.

12. A method executed on a computing device to enhance a contact card based on a knowledge graph, the method comprising:
receiving a communication from an organization;
processing the communication to identify an association information between a recipient of the communication and the organization;
adding the association information into a knowledge graph;
querying the knowledge graph to retrieve the association information, wherein the association information matches an interest of the recipient;
inserting the association information to a smart contact card of the organization, wherein a control element to interact with the association information is inserted into the smart contact card; and
presenting the smart contact card to the recipient.

13. The method of claim 12, further comprising:
searching the knowledge graph for a related communication sent by the organization; and
inserting a link to the related communication into the smart contact card as the association information.

14. The method of claim 12, further comprising:
searching the knowledge graph for a document related to the organization; and
inserting a link to the document into the smart contact card as the association information.

15. The method of claim 12, further comprising:
searching the knowledge graph for a review associated with the organization; and
inserting the review into the smart contact card as the association information.

16. The method of claim 12, further comprising:
searching the knowledge graph for a third party information source with an article on the organization; and
inserting a link to the third party information source with the article on the organization as the association information into the smart contact card.

17. The method of claim 12, further comprising:
detecting a classification of the organization as a favorite by the recipient;
storing the organization as the favorite in the knowledge graph; and
inserting an indicator into the smart contact card to label the organization as the favorite.

18. A computer-readable memory device with instructions stored thereon to enhance a contact card based on a knowledge graph, the instructions comprising:
receiving a communication from an organization;
processing the communication to identify an association information between a recipient of the communication and the organization;
adding the association information into a knowledge graph;
querying the knowledge graph to retrieve the association information, wherein the association information matches an interest of the recipient;
inserting the association information to a smart contact card of the organization, wherein a control element to interact with the association information is inserted into the smart contact card; and
presenting the smart contact card to the recipient.

19. The computer-readable memory device of claim 18, wherein the instructions further comprise:
identifying a location of the recipient;
querying the knowledge graph to detect a nearest location of a store of the organization in relation to the location of the recipient;
inserting the nearest location of the store of the organization as the association information into the smart contact card;
providing the association information with a link to a map with directions from the location of the recipient to the nearest location of the store of the organization; and
including a graphical representation of the map in the information.

20. The computer-readable memory device of claim 18, wherein the instructions further comprise:
querying the knowledge graph for a promotion offered by the organization;
verifying the interest of the recipient in an item described by the promotion by confirming a past purchase of the item by the recipient;
inserting the promotion as the association information into the smart contact card;
querying the knowledge graph for other promotions offered by the organization;
detecting the interest of the recipient in a subset of the other promotions based on a past purchase history of the recipient for other items in the subset of the other promotions; and
adding the subset of the other promotions into the association information for presentation in the smart contact card.
